(19) United States
(12) Patent Application Publication
(10) Pub. No.: US 2019/0044750 A1
(43) Pub. Date: Feb. 7, 2019

(54) SWITCHING CELL, CAN BUS NETWORK AND RECONFIGURATION METHOD

(71) Applicant: HEWLETT-PACKARD DEVELOPMENT COMPANY, L.P., Houston, TX (US)

(72) Inventors: Vicente Granados, Sant Cugat del Valles (ES); David Soriano, Terrassa (ES); Anna Torrent, Barcelona (ES)

(73) Assignee: HEWLETT-PACKARD DEVELOPMENT COMPANY, L.P., Houston, TX (US)

(21) Appl. No.: 16/071,862

(22) PCT Filed: Apr. 22, 2016
(86) PCT No.: PCT/EP2016/059101

§ 371 Date: Jul. 20, 2018

(51) Int. Cl. H04L 12/40; H04L 12/24

(52) U.S. Cl. CPC H04L 12/40169; H04L 2012/40215; H04L 41/0677; H04L 41/0654

(57) ABSTRACT

A method and apparatus to reconfigure a CAN bus network after a failure comprising providing the network with a control device and one or more node devices in a closed loop of CAN bus lines, detecting if there is a failure in the network and reconfiguring the network if a failure is detected. Reconfiguring the network when a failure has been detected comprises decoupling each of the plurality of devices in the network from the CAN bus line, configuring the network to terminate signals in a first device closest to the failure on one side of the failure, configuring the network to terminate signals in a second device closest to the failure on the other side of the failure and coupling a first side of each device with a second side of an adjacent device other than the first side of the second device and the second side of the first device.

### BACKGROUND

Controller Area Network (CAN) bus networks are networks in which all the devices in the network can communicate with each other without a host computer. If a failure occurs somewhere in the network, intercommunication between each and all of the devices may be lost.

### BRIEF INTRODUCTION OF THE DRAWINGS

Examples of the disclosure are further described hereinafter with reference to the accompanying drawings, in which:

FIG. 1 shows a schematic diagram of one example switching cell for use in a CAN bus network device in accordance with an example of the present disclosure showing high and low differential lines;

FIG. 2 shows a simplified schematic diagram of one example switching cell for use in a CAN bus network device in accordance with an example of the present disclosure showing one line to indicate both high and low differential lines;

FIG. 3 is a schematic diagram of one example CAN bus network device in accordance with an example of the present disclosure;

FIGS. 4A and B are respectively a flowchart in accordance with an example of the present disclosure of a method for reconfiguring a CAN bus network after a failure, and a schematic representation of the resulting, reconfigured network;

FIG. 5 is a schematic diagram of one example network of CAN bus network devices;

FIG. 6 is a schematic diagram of one example network of CAN bus network devices with a failure in a location of the CAN bus;

FIG. 7 is a schematic diagram of the example network of FIG. 6 with all of the devices decoupled from the CAN bus line;

FIG. 8 is a schematic diagram of the example network of FIG. 6 in a final state after reconfiguring for a failure in a location of the CAN bus;

FIG. 9 is a schematic diagram of one example network of CAN bus network devices with a failure in one of the CAN bus devices;

FIG. 10 is a schematic diagram of the example network of FIG. 9 in a final state after reconfiguring for a failure in one of the CAN bus devices;

### DETAILED DESCRIPTION

A Control Area Network (CAN) bus is a communication network that allows devices in a network to communicate with each other without a host computer. The CAN bus is a differential serial bus that needs to be terminated at both ends to stop a signal reflecting back along the bus and the reflected signal creating interference with the original signal. Therefore, terminating the signal improves the signal integrity. Signal integrity becomes more important the faster the speed that the CAN bus is used at.

If there is a failure in the network, for example, in one of the devices in the network or in a portion of CAN bus line in the CAN bus, communication between all of the devices in the network may be lost and the devices in the network may stop working. Furthermore, the devices are not able to diagnose where in the network there is a failure, for example, which device is responsible for the failure or which portion of CAN bus line contains a fault.

According to some described examples, a solution is provided herein to diagnose the location of the failure and to isolate this location from the CAN bus network to recover communication between all working devices in the network. In the case that the failure is in a portion of the CAN bus line this portion of CAN bus line can be isolated from the network and all of the devices can be recovered to communicate with each other. In the case that the failure is in one of the devices in the network, this device can be isolated and all other devices in the network can be recovered to communicate with each other.

A CAN bus device in accordance with the present disclosure comprises a CAN transceiver, a first detector, a second detector and a switching cell. The switching cell comprises a first switch, a second switch and a third switch wherein the second switch is coupled to a terminator. A microcontroller may control operation of the first second and third switches. Also disclosed is a network of CAN bus network devices and a method to reconfigure a CAN bus network after a failure.

According to some examples, to reconfigure a CAN bus network after a failure, the network is configured to terminate signals on a second side of a first device closest to the failure on one side of the failure and to terminate signals on a first side of a second device closest to the failure on the other side of the failure.

A switching cell comprises a first switch, a second switch and a third switch. The first switch may be coupled to a CAN bus line on the first side of the CAN bus network device, the second switch may be coupled to a terminator and the third switch may be coupled to the CAN bus line on the second side of the CAN bus network device. The first switch, the second switch and the third switch may be coupled to one another. A microcontroller may control operation of the first second and third switches. The switching cell is configured to transfer a signal through the switching cell when the first switch and the third switch are in the closed position and the second switch is in the open position. Furthermore, the switching cell is configured to terminate the signal when the first switch and the second switch are in the closed position and the third switch is in the open position or when the second switch and the third switch are in the closed position and the first switch is in the open position. It will be appreciated that the switching cell thus permits termination of the CAN bus network line on either side of the device.

The second switch in the switching cell may be a logical function of the first switch and the third switch, so that the second switch will be open only if both the first switch and the third switch are closed.

A CAN bus network is disclosed and can include a control device and two or more node devices, wherein the control device and each of the plurality of node devices are coupled to two other device in the network in a closed loop configuration by a CAN bus line. The control device contains a switching cell, for example, the above described switching cell, and a CAN transceiver. The one or more node devices may also contain a switching cell, for example, the above described switching cell, and a CAN transceiver. In some examples, the switching cell may be integrated within the transceiver. Being in a closed loop configuration enables messages between components to be directed in either direction around the loop, depending one where the CAN bus line is terminated. The network can be configured to terminate the CAN bus line at any two devices. Where the network and its devices are fully operational, terminations can be between the control device and an adjacent node device.

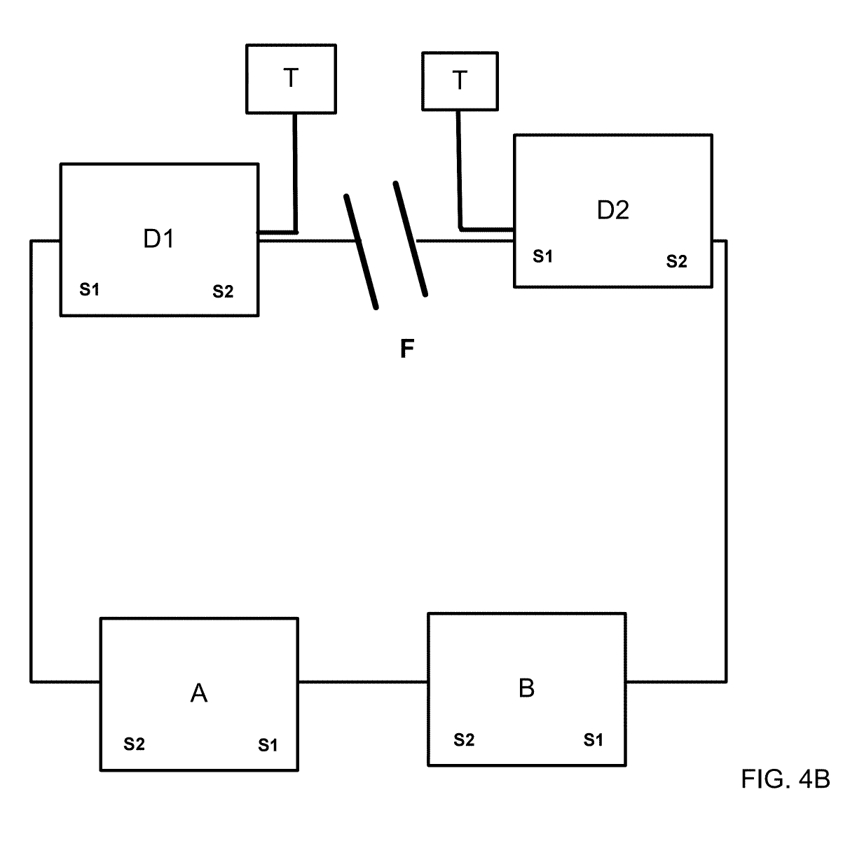

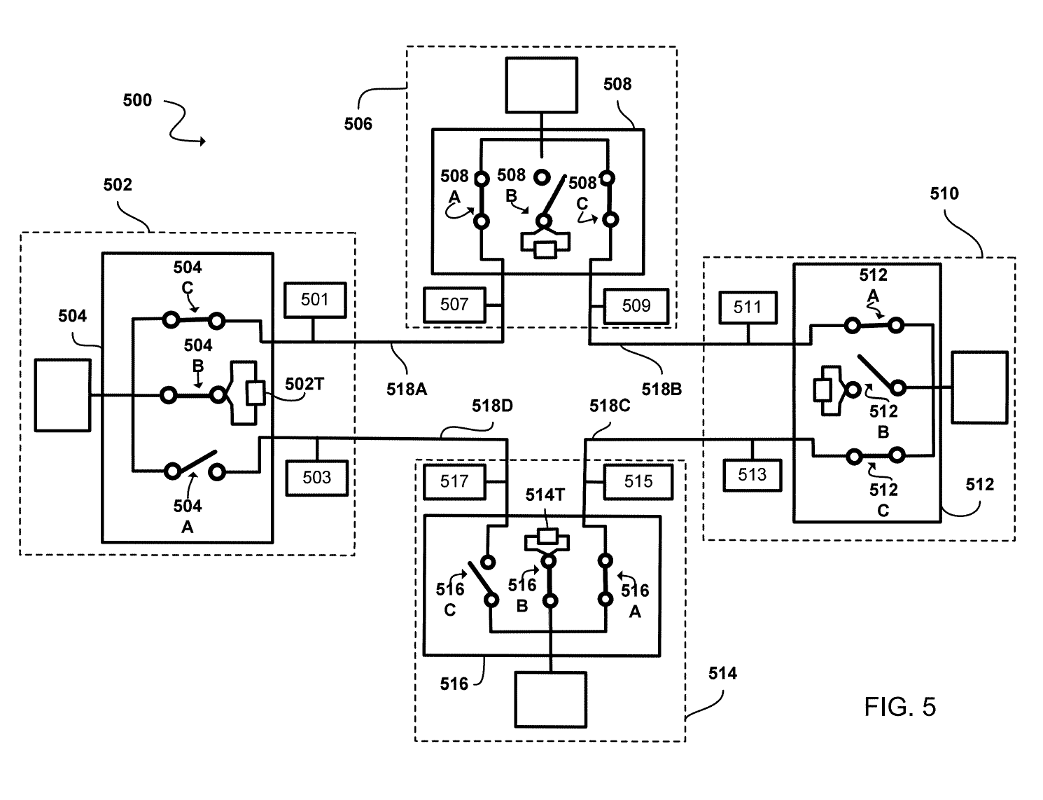

Methods to reconfigure a CAN bus network after a failure are herein disclosed. FIG. 4 illustrates an example method 400 for reconfiguring a CAN bus network after a failure that can be performed by the example CAN bus network of FIG. 5 (described further below). According to the method 400 of FIG. 4A, it is detected if there is a failure 401. If no failure is detected 402 in the network then no further action is taken. If a failure is detected then all of the devices in the network are decoupled 404 from the CAN bus line. A second side of a first device closest to the failure on one side of the failure is configured to terminate signals on the CAN bus line 405, and a first side of a second device closest to the failure on the other side of the failure is configured to terminate signals on the CAN bus line 406. A first side of each device is coupled with a second side of an adjacent device, other than the first side of the second device closest to the failure on the first side, which is configured to terminate signals on the CAN bus line, and the second side of the first device closest to the failure on the second side, which is also configured to terminates signals on the CAN bus line 407.

FIG. 4B shows the resulting network, where side S1 of device D2, and side S2 of device D1 are each isolated from failure F and instead terminated at T, while each device A, B, D1 and D2 are interconnected between their respective sides S1 and S2, other than S1 of D2 and S2 of D1, which are terminated.

In some examples, a failure in the network is detected by transmitting a first prompting signal from the control device onto the CAN bus line on a second side of the control device. The CAN bus line on a first side of the control device is monitored for the return of the first prompting signal. If a first detector on the first side of the control device detects the return of the first prompting signal there is a complete unbroken connection through the network between the control device and the last node device in the network. Thus, in this case there is not a failure in the network. If the detector on the first side of the control device does not detect the return of the first prompting signal, the signal must have been stopped by a break in the circuit. Thus, in this case, there is a failure in the network.

In some examples, each device in the network comprises a switching cell as described above. This switching cell comprises a first switch, a second switch and a third switch. The first prompting signal can be transmitted from the control device onto the CAN bus line by closing the third switch in the switching cell in the control device. In some examples, each switching cell within the plurality of network devices further comprises a terminator coupled to the second switch in the switching cell and the first switch coupled to the CAN bus line on a first side of the device and the third switch coupled to the CAN bus line on a second side of the device. The devices in the network may be decoupled from the CAN bus line, after a failure has been detected, by opening the first switch in each device to disconnect each device from the CAN bus line on the first side of each of the plurality of devices, opening the third switch in each device to disconnect each device from the CAN bus line on the second side of each of the plurality of devices; and closing the second switch in the switching cell in each device to connect each device to the terminator.

In some examples, each node device in the network is reconfigured in turn. A first detector on the first side of each node device may detect the first prompting signal originally transmitted by the control device. When the first detector detects the first prompting signal, the first switch in the switching cell of each node device closes. A second detector on the second side of each node device may detect a first responding signal. When the second detector detects the first responding signal, the third switch in the switching cell of each node device closes. The second switch may be a logical function of the first switch and the third switch so that when the first switch and the third switch are closed the second switch is open. A node device may be configured to transfer signals through the node device when the first switch and the third switch are closed and the second switch is open. A node device may also be configured to route signals to be terminated by a terminator when either the first switch and the second switch are closed and the third switch is open or when the second switch and the third switch are closed and the first switch is open.

Transmitting the first prompting signal by the control device starts a chain reaction to configure all of the node devices up to the failure in the network on the first side of the failure in the network. In order to configure all the other node devices in the network on the second side of the failure, the first switch in the control device may be temporarily closed and a second prompting signal temporarily transmitted from the control device onto the CAN bus line on the first side of the control device and the second side of the failure. However, before commencing to configure all the other node devices, enough time is allowed to pass to ensure that the first prompting signal could have reached the first side of the control device in the absence of a failure.

The second detector on the second side of each node device may detect the second prompting signal temporarily transmitted by the control device. When the second detector detects the second prompting signal, the third switch in the switching cell of each node device closes. The first detector on the first side of each node device may detect a second responding signal. When the first detector detects the second responding signal, the first switch in the switching cell of each node device closes. As stated above, the second switch may be a logical function of the first switch and the third switch so that when the first switch and the third switch are closed the second switch is open. The node device may be configured to transfer signals through the node device when the first switch and the third switch are closed and the second switch is open. A node device may also be configured to route signals to be terminated by the terminator when either the first switch and the second switch are closed and the third switch is open or when the second switch and the third switch are closed and the first switch is open.

Each of the first and second prompting signals and first and second responding signals may be transmitted by a respective transceiver of each network device and may comprise a simple voltage on the CAN bus line to indicate it is a live line and ready to transmit messages. In this event, the detectors merely respond to a voltage level in the line under examination. Alternatively, the signals may be more sophisticated and comprise further information.

[0029]Thus, each node device with respect to an adjacent node device can be either a prompting node device or a responding node device, the adjacent node device being the other of the prompting node device and responding node device. The closing of the first switch in the switching cell in each responding node device when the first prompting signal is detected by the first detector, may further comprise temporarily closing the third switch in that responding node device, which then assumes the position of prompting node device with respect to the next adjacent node device. However, the third switch does not close immediately the first switch closes, but rather it closes after a short delay that is sufficient to allow the second detector of the preceding node device to detect the responding signal and definitively close the third switch of the preceding device. When the third switch of the prompting node device closes, that allows temporary transmission of the first prompting signal, which itself results in closing the first switch in the next adjacent responding node device when the first detector of the responding node device detects the first prompting signal. The closing of the third switch in the switching cell in each node device when the first responding signal is detected by the second detector may further comprise transmitting the first responding signal, by the responding node device, back along the CAN bus line on the first side of the responding node device to the prompting node device, monitoring the CAN bus line on the second side of the prompting node device for the first responding signal transmitted by the responding node device and definitively closing the third switch in the prompting node device if the second detector of the prompting node device detects the first responding signal. When a switch is described herein as being closed definitively, this is to indicate that the assessment of the device is complete and the switch will not be reopened again unless the network is reset.

Furthermore, the closing of the third switch in the switching cell in each node device when the second prompting signal is detected by the second detector may further comprise temporarily closing the first switch in the responding node device. Again, the first switch does not close immediately the third switch closes, but rather it closes after a short delay that is sufficient to allow the first detector of the preceding node device to detect the responding signal and definitively close the first switch of the preceding device. When the first switch of the prompting node device closes, that allows temporary transmission of the second prompting signal, which itself results in closing the third switch in the responding node device when the second detector of the responding node device detects the second prompting signal. The closing of the first switch in the switching cell in each node device when the second responding signal is detected by the first detector may further comprise transmitting the second responding signal, by the responding node device, back along the CAN bus line on the second side of the responding node device to the prompting node device, monitoring the CAN bus line on the first side of the prompting node device for the second responding signal transmitted by the responding node device and definitively closing the first switch in the prompting node device if the first detector of the prompting node device detects the second responding signal.

The control device may monitor the CAN bus line on the first side of the control device for the second responding signal. The first switch in the switching cell in the control device may be closed definitively if the first detector of the control device detects the second responding signal after a predetermined period of time. The predetermined period may be a period of time long enough to allow all the device nodes in the network up to the failure to be connected.

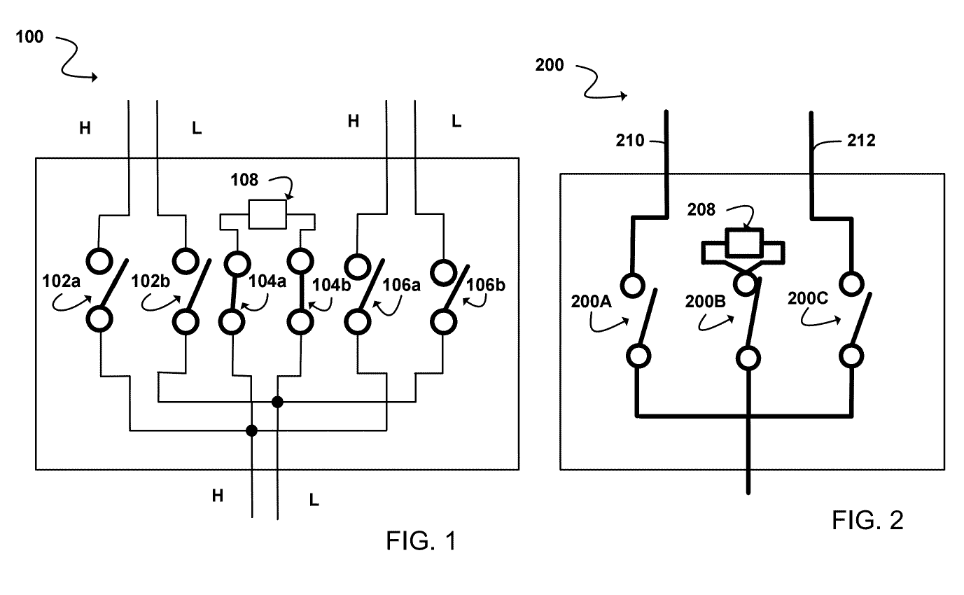

FIG. 1 shows an example switching cell. It shows a differential two-wire bus comprised of one high CAN bus line (H) and one low CAN bus line (L). CAN bus communication relies on a voltage differential between the two bus lines (H, L) to improve resilience to inductive spikes, electrical fields or other noise. Switches 102a, 104a and 106a are coupled by the high CAN bus line H and switches 102b, 104b and 106b are coupled by the low CAN bus line L. Switch 102a couples to a high CAN bus output line on a first side of the switching cell, switch 104a couples through a high CAN bus line to a terminator 108 and switch 106a couples to a high CAN bus output line on a second side of the switching cell. Similarly, switch 102b couples to a low CAN bus output line on the first side of the switching cell, switch 104b couples through a low CAN bus line to the terminator 108 and switch 106b couples to a low CAN bus output line on the second side of the switching cell. The terminator stops communication signals from network devices reflecting back along CAN bus lines so that reflected signals cannot create interference with the oncoming communication signals which improves signal integrity in the network. In some examples, the terminator may be a resistor, for example, a 120 ohm resistor. The high CAN bus line (H) and the low CAN bus line (L) transmit signals contemporaneously, thus, the switches in FIG. 1 work in pairs. For example, switches 102a and 102b will open and close simultaneously, as will switches 104a with 104b and 106a with 106b. For simplicity the high CAN bus line (H) and low CAN bus line (L) are referred to and shown as one bus throughout the rest of the disclosure.

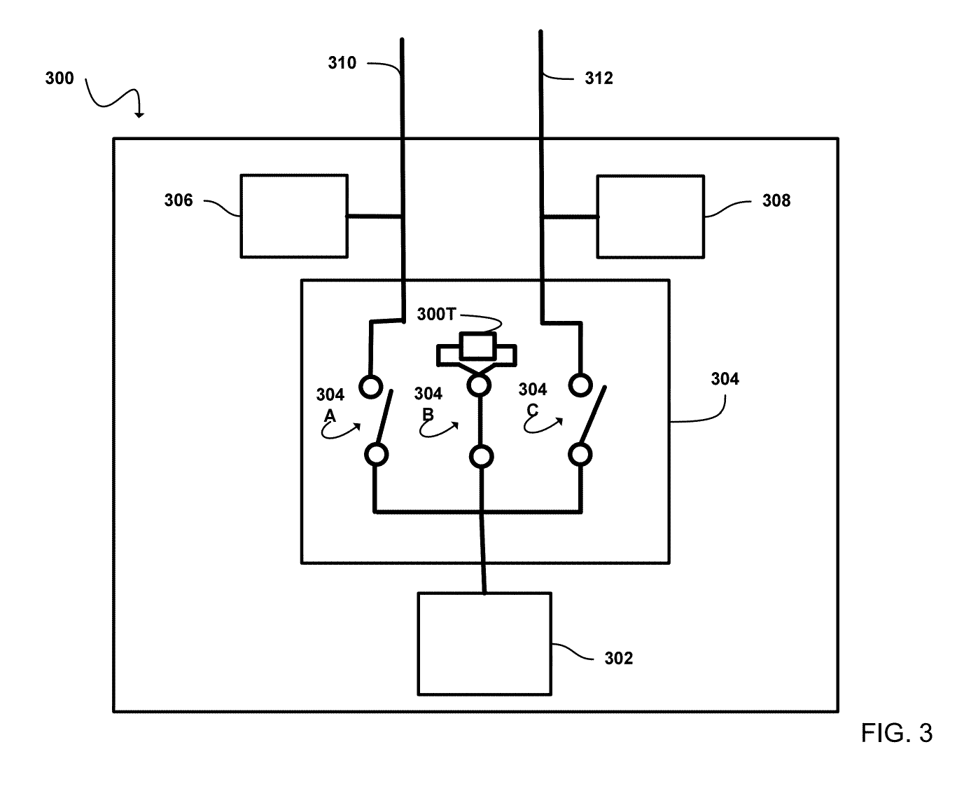

FIG. 2 shows an example switching cell for use in the CAN bus network device of the present disclosure wherein the high CAN bus line (H) and low CAN bus line (L) are shown as one bus. Switch 200A is coupled to the CAN bus line 210 on a first side of the switching cell. Switch 200B is coupled to terminator 208. Switch 200C is coupled to the CAN bus line 212 on a second side of the switching cell. Switches 200A, 200B and 200C are interconnected. Switch 200B may be a logical function of switch 200A and switch 200C so that switch 200B will be open only if both switch 200A and switch 200C are closed. A microcontroller (not shown) may control the switches 200A, 200B and 200C. Signals arriving on CAN bus line 210 will be transferred around terminator 208 and out the switching cell through CAN bus line 212 when switch 200B is open and switches 200A and 200C are closed. Furthermore, signals arriving on CAN bus line 212 will be transferred around terminator 208 and out the switching cell through CAN bus line 210 when switch 200B is open and switches 200A and 200C are closed. Signals arriving on CAN bus line 210 will be routed to terminator 208 when switches 200A and 200B are closed and switch 200C is open and signals arriving on CAN bus line 212 will be routed to terminator 208 when switches 200C and 200B are closed and switch 200A is open. A memory within a device, that the switching cell of FIG. 2 may be implemented within, may contain instructions that, when executed on a processor, perform the actions of closing and opening the switches in the switching cell. The processor may receive information from detectors associated with the switches about received communication signals and the switching cell may be configured accordingly.

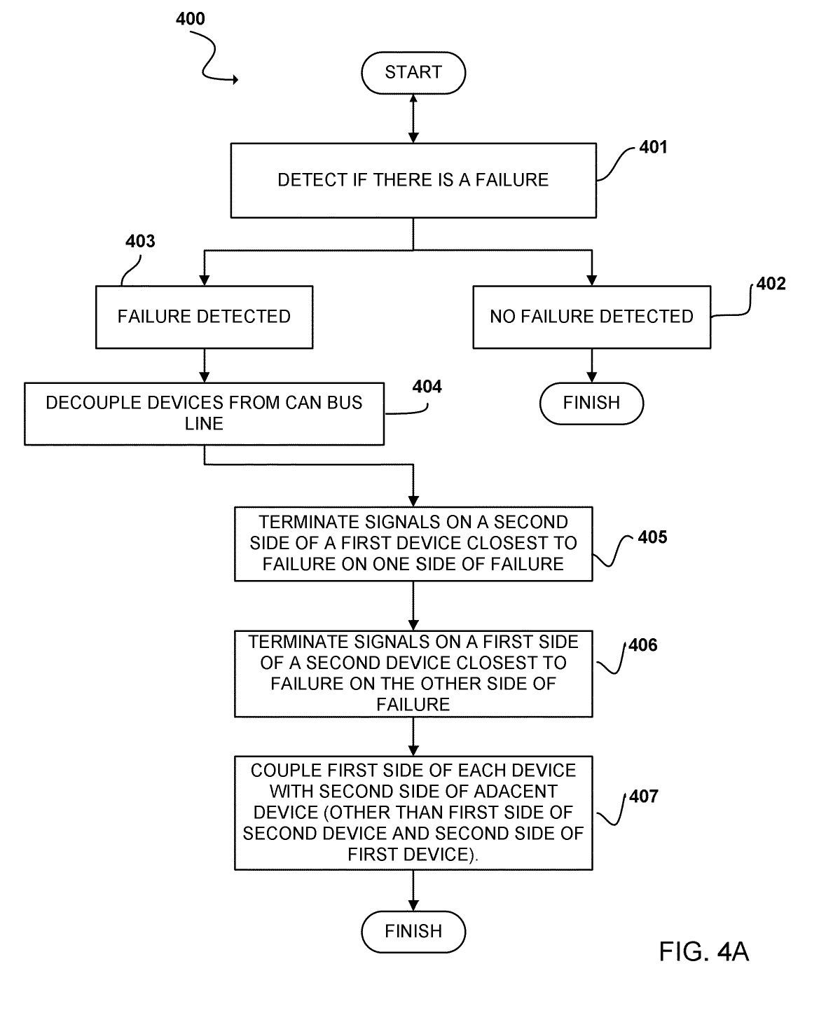

FIG. 3 shows an example CAN bus network device 300 and includes the switching cell 304 of FIG. 2. A CAN bus line connects the switching cell 304 to a CAN transceiver 302. A first detector 306 is connected to CAN bus line 310 on a first side of the device and can detect signals from CAN bus line 310. A second detector 308 is connected to the CAN bus line 312 on the second side of the device and can detect signals from CAN bus line 312. A memory (not shown) within device 300 may contain instructions that, when executed on a processor, perform the actions of closing and opening the switches in the switching cell based on information received from detectors associated with the switches about network signals received on the CAN bus lines and the switching cell may be configured accordingly. For example, detector 306 may detect signals arriving on CAN bus line 310. The detector may inform the device processor (not shown) of this signal detection and the processor may execute instruction stored on a memory (not shown) in the device to close switch 304A.

FIG. 5 is a schematic diagram of one example network 500 comprising CAN bus network devices as shown in FIG. 3. Network 500 here comprises four of the CAN bus network devices of FIG. 3, one of which is a control device 502 and three of which are node devices 506, 510, 514. Devices 502, 506, 510, 514 are connected by CAN bus lines 518A-D in a closed loop. More precisely, the second side of control device 502 is coupled by CAN bus line 518A to the first side of node device 506; the second side of node device 506 is coupled by CAN bus line 518B to the first side of node device 510; the second side of node device 510 is coupled by CAN bus line 518C to the first side of node device 514; and, the second side of node device 514 is coupled by CAN bus line 518D to the first side of the control device 502. The control device is configured to route signals arriving on CAN bus line 518A to terminator 502T. This is achieved by having switch 504C and 504B in their closed positions and switch 504A in the open position. Also, node device 514 is configured to route signals arriving on CAN bus line 518C to terminator 514T. This is achieved by having switch 514A and 514B in their closed positions and switch 504C in the open position. This configuration means all the devices in the network are interconnected by the CAN bus in a daisy chain configuration and can all communicate with each other through the CAN bus line wherein the CAN bus line is terminated at the start and end of the daisy chain in devices 502 and 514. Terminating the CAN bus line at both ends reduces signal reflection which can lead to interference between the reflected signal and a transmitted signal causing a potentially unacceptable loss in signal quality. In this case, CAN bus line 518D does not transmit signals as switch 504A in control device 502 is open and switch 516C in node device 514 is open.

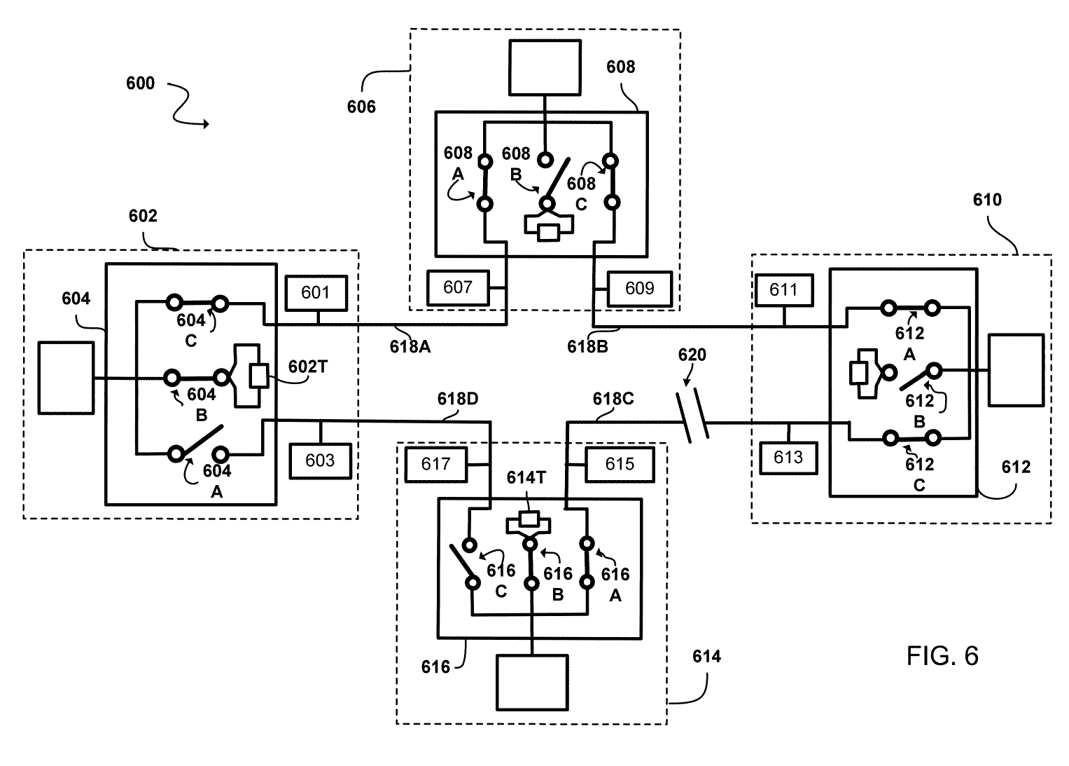

FIG. 6 shows one example network of CAN bus network devices with a failure 620 in a location of the CAN bus line. In this example, the failure is shown in the CAN bus line 618C that couples node devices 610 and 614. In this case, device 614 is isolated and cannot communicate with the rest of the network, and the rest of the network is not terminated at one end where the failure 620 is located. As a result, interference between reflected signals and transmitted signals may cause unacceptable signal quality. In one example, a method to refigure network 600 so that device 614 can communicate with the other devices in the network and so that signals are terminated at both ends of the network is herein described.

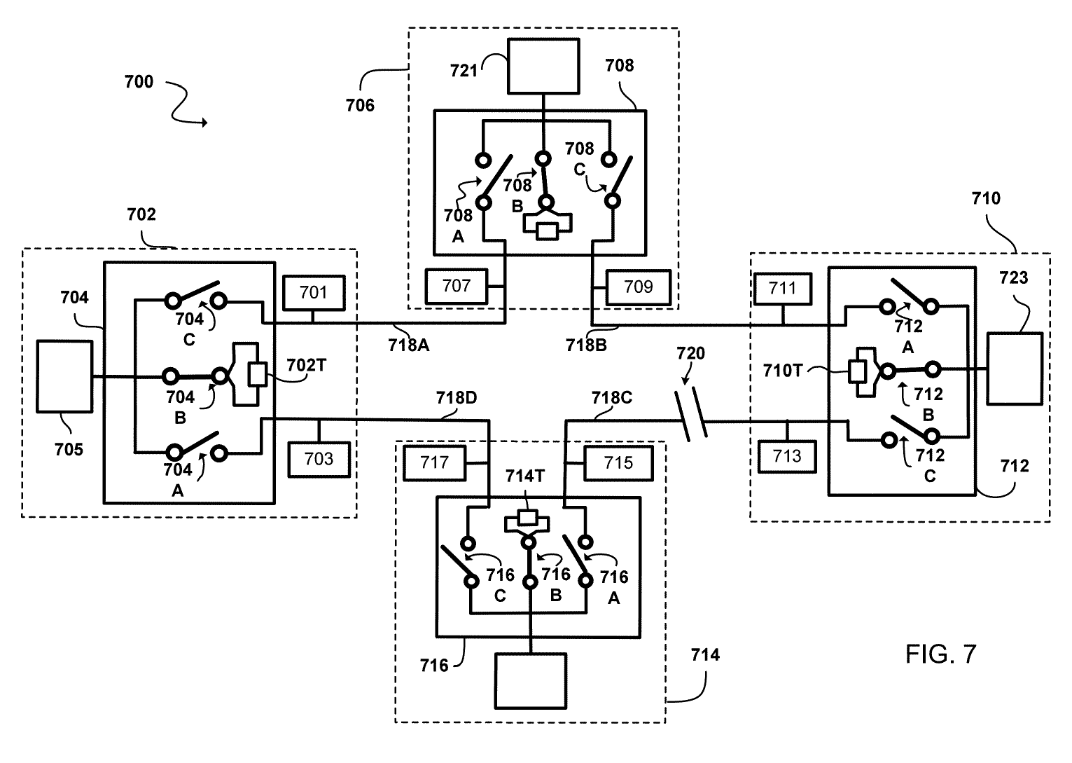

To reconfigure network 600, all the devices in the network are decoupled from the CAN bus line. One example of all the devices in the network being decoupled is shown in FIG. 7. For device 702, switch 704A is opened to disconnect the device from CAN bus line 718D, switch 704C is opened to disconnect the device from CAN bus line 718A, and switch 704B is closed. Similarly, to decouple device 706 from the CAN bus line, switch 708A is opened to disconnect the device from CAN bus line 718A, switch 708C is opened to disconnect the device from CAN bus line 718B, and switch 708B is closed. To decouple device 710 from the CAN bus line, switch 712A is opened to disconnect the device from CAN bus line 718B and switch 712C is opened to disconnect the device from CAN bus line 718C, switch 712B is closed. To decouple device 714 from the CAN bus line, switch 716A is opened to disconnect the device from CAN bus line 718C and switch 716C is opened to disconnect the device from CAN bus line 718D, switch 716B is closed.

After all the devices have been decoupled they may be ready to be reconfigured. With further reference to FIG. 7, the example network 700, with failure 720, may be reconfigured by temporarily closing third switch 704C in the control device to start the connection and transmit a first prompting signal (by transceiver 705 of the control device 702) onto CAN bus 718A. Detector 707 of device 706 may detect the first prompting signal arriving on CAN bus line 718A and, as a result, may be arranged to close switch 708A in the switching cell 708 of device 706. In the meantime, third switch 704C in control device 702 is opened, isolating detector 701 from its transceiver 705. Now, however, device 706 is connected to CAN bus line 718A via closed switch 708A, and a first responding signal can be transmitted by transceiver 721 of cell 706 back along CAN bus line 718A towards device 702. Detector 701 of control device 702 may detect the first responding signal arriving on CAN bus line 718A and may cause switch 704C to close and to remain closed definitively. In cell 706, switch 708A remains closed.

The reconfiguration of control device 702 with respect to device 706, and their interconnecting CAN bus line 718A, is therefore finished. In this configuration, device 702 acts as the prompting node device and device 706 acts as the responding node device.

Next, after a short delay (enough time to allow switch 704C to be closed definitively and to avoid interference from signals on line 718B, as described further below) switch 708C may be temporarily closed, temporarily opening switch 708B, to enable the first prompting signal to be transmitted (by transceiver 721 of node device 706, as well as transceiver 705) onto CAN bus line 718B. Detector 711 of device 710 may detect the first prompting signal arriving on CAN bus line 718B and may close switch 712A in the switching cell 712 of device 710. In the meantime, switch 708C opens again, isolating detector 709 from transceiver 721 and the control device 702.

Now that device 710 is connected to CAN bus line 718B via closed switch 712A a first responding signal can be transmitted back along CAN bus line 718B towards device 706 (by transceiver 723 of node device 710). Detector 709 of device 706 may detect the first responding signal arriving on CAN bus line 718B and may close switch 708C definitively (ie not temporarily).

The reconfiguration of device 706 with respect to device 710, and their interconnecting CAN bus line 718B, is therefore finished and device 706 (and CAN bus line 718B) has been reconfigured to transfer signals through the device. In this configuration, device 706 acts as the prompting node device and device 710 acts as the responding node device.

To configure the next device in the network, switch 712C may be temporarily closed (again, after a short delay to prevent any signals in line 718C interfering with the first responding signal transmitted by transceiver 723 onto line 718B and confusing reception by detector 709 of the first responding signal). Closing switch 712C causes temporary opening of switch 712B and also enables the first prompting signal (now transmitted by transceiver 723 of node device 710, as well as transceivers 705 and 721) to be transmitted onto CAN bus line 718C. In this example, there is a failure 720 in CAN bus line 718C so the first prompting signal cannot reach device 714 and detector 715 of device 714 cannot detect the first prompting signal. As a result, switch 716A in the switching cell 716 of device 714 does not close. Thus, device 714 is not connected to CAN bus line 718C and device 714 does not act as the responding node to node device 710, which in this instance is the prompting node device. Therefore, no first responding signal is transmitted back along CAN bus line 718C towards prompting device 710. Detector 713 of device 710 therefore fails to detect any first responding signal. As a result, switch 712C, after having been opened after temporarily transmitting the first prompting signal to CAN bus line 718C, remains open and switch 712B remains closed.

The reconfiguration of device 710 is therefore finished and device 710 has been reconfigured to route signals arriving from CAN bus line 718B to terminator 710T.

After a predetermined period of time (sufficient for the first prompting signal to return to the control device 702 and be detected by detector 703 when there is no failure in the network 700), and the first prompting signal has not returned to control device 702 and been detected by detector 703, switch 704A in the control device 702 is temporarily closed, temporarily opening switch 704B. This enables a second prompting signal to be transmitted by the control device acting as a prompting node device onto CAN bus line 718D towards device 714 acting as a responding device. The second prompting signal is transmitted by transceiver 705, but also by transceivers 721 and 723 already forming a CAN bus network. Detector 717 of device 714 may detect the second prompting signal arriving on CAN bus line 718D and in response may close switch 716C in the switching cell 716 of device 714. In the meantime, switch 704A opens, isolating detector 703 from the transceiver 705.

When switch 716C in responding node device 714 closes, a second responding signal is transmitted by the transceiver of device 714 back along CAN bus line 718D and is detected by detector 703, whereupon switch 704A is closed definitively and switch 704B opened, whereby a network connection between control device 702 and node device 714 is established.

After sufficient time to allow the foregoing signal detection by detector 703 of the second responding signal, switch 716A may be temporarily closed, temporarily opening switch 716B. This enable the second prompting signal to be transmitted onto CAN bus line 718C. In this example, there is the failure 720 in this

CAN bus line 718C, and so the second prompting signal cannot reach device 710 and detector 713 of device 710 cannot detect the second prompting signal. As detector 713 of device 710 cannot detect the second prompting signal, switch 712C in the switching cell 712 of device 710 does not close. Thus, device 710 is not connected to CAN bus line 718C or to device 714. In this case, device 710 cannot act as the responding node to prompting node device 714 and a second responding signal cannot be transmitted back along CAN bus line 718C towards device 714. Thus, after switch 716A opens after its temporary closure, detector 715 of device 714 does not detect a second responding signal. As a result, switch 716A, after having been opened after temporarily transmitting the second prompting signal onto CAN bus line 718C, remains open and switch 716B remains closed. The reconfiguration of device 714 is therefore finished and device 714 is reconfigured to route signals arriving from CAN bus line 718D to terminator 714T.

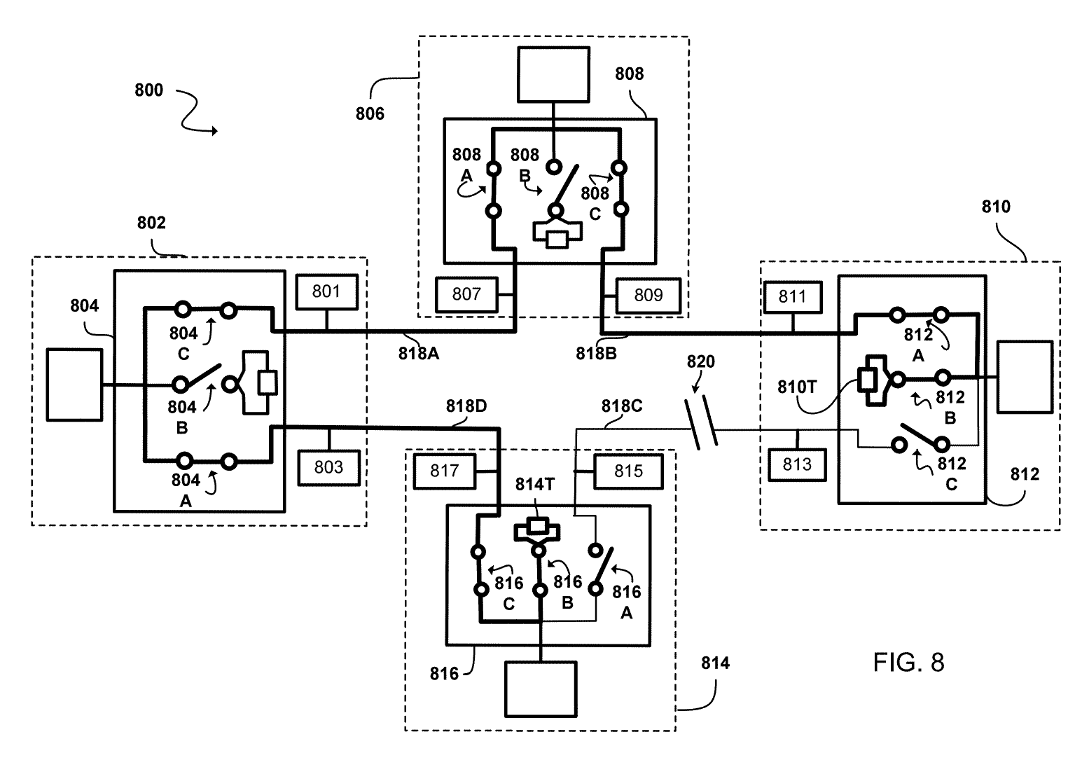

The network 700 is thus reconfigured to transfer signals through it. FIG. 8 shows the example network of FIG. 6 in a final state after reconfiguring for the failure in a section of the CAN bus line. The bold line indicates a connected CAN bus line capable of transmitting communications between the network devices and the thin line indicates an unconnected section of CAN bus line where the failure 820 is located and that is not capable of transmitting communications. In this example reconfigured network, signals are terminated at terminator 810T of device 810 and terminator 814T of device 814 and the section of CAN bus line containing the failure 820 is isolated from the rest of the network.

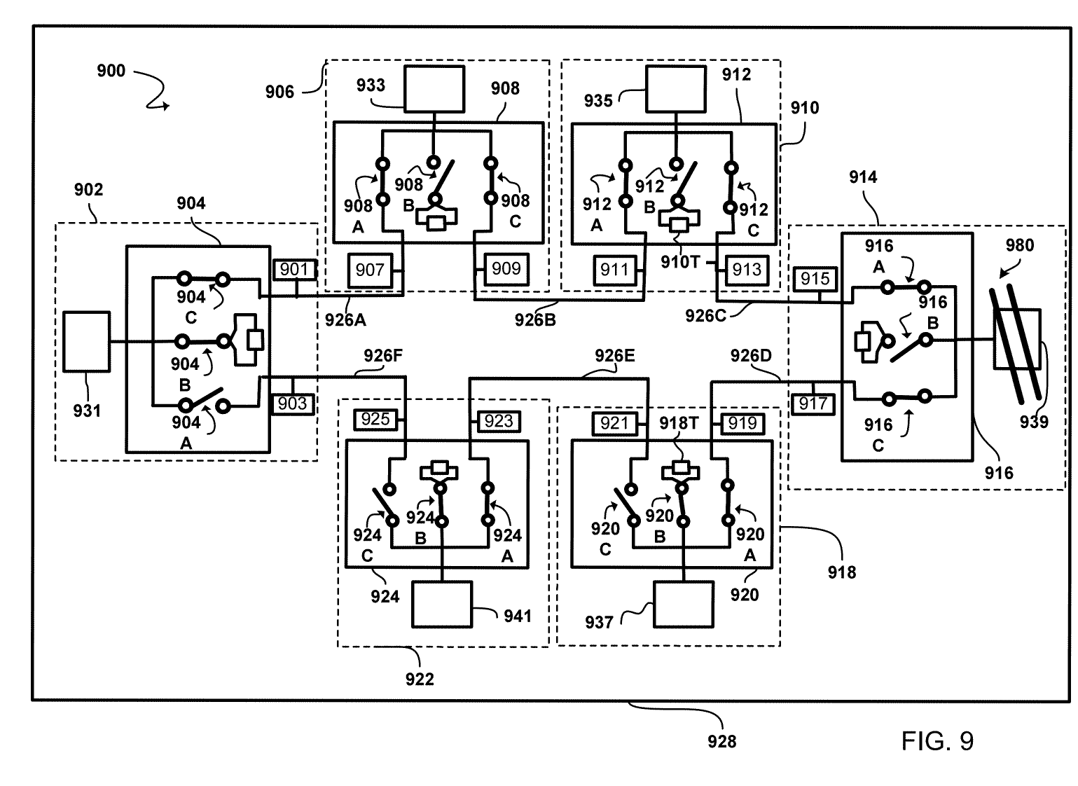

FIG. 9 is a schematic diagram of one example network 900 of CAN bus network devices with a failure in one of the CAN bus devices. Example network 900 comprises a control device and five node devices with a failure in node device 914. To reconfigure the network 900, the same procedure as described above with reference to FIG. 6 may be followed to detect if there is a failure in the network and to decouple the devices in the network 900 from the CAN bus line. After all the devices have been decoupled they may be ready to be reconfigured. The example network 900 has a failure 980 in device 914.

The network 900 may be reconfigured by temporarily closing switch 904C to start the connection and transmit from transceiver 931 of the control device 902 a first prompting signal onto CAN bus 926A. Detector 907 of device 906 may detect the first prompting signal arriving on CAN bus line 926A and may close switch 908A in the switching cell 908 of device 906. After switch 904C has opened, transceiver 933 of the node device 906 may transmit a first responding signal in CAN bus line 926A, which first responding signal is detected by detector 901 of control device 902 which thereupon recloses switch 904C, and the connection between devices 902 and 906 is complete.

Then, switch 908C may be temporarily closed, temporarily opening switch 908B, to enable the first prompting signal to be transmitted onto CAN bus line 926B (by transceivers 933 and 931). Detector 911 of device 910 may detect the first prompting signal arriving on CAN bus line 926B and switch 912A may be closed in the switching cell 912 of device 910. Now that device 910 is connected to CAN bus line 926A via closed switch 912A a first responding signal can be transmitted back along CAN bus line 926B towards device 906. After switch 908C has opened after its temporary closure, detector 909 of device 906 may detect the first responding signal arriving on CAN bus line 926B and may close switch 908C definitively. Device 906 is thus reconfigured with respect to device 910 and has been reconfigured to transfer signals through the device. In this configuration, device 906 has acted as the prompting node device and device 910 has acted as the responding node device.

To configure the next device in the network, switch 912C may be temporarily closed, temporarily opening switch 912B, to enable the first prompting signal to be transmitted onto CAN bus line 926C. In this example, there is a failure 980 in node device 914. The first prompting signal may not reach device 914 and detector 915 of device 914 may not detect the first prompting signal. As detector 915 of device 914 does not detect the first prompting signal, switch 916A in the switching cell 916 of device 914 does not close. Thus, device 914 is not connected to CAN bus line 926C or device 914. Thus, device 914 does not act as the responding node to prompting device 910 and a first responding signal is not be transmitted back along CAN bus line 926C towards device 910. Detector 913 of device 910 does not detect the first responding signal and, thus, switch 912C remains open and switch 912B remains closed. Device 910 is thus reconfigured and has been reconfigured to route signals arriving from CAN bus line 926B to terminator 910T.

It is to be noted that the failure 980 of node device 914 could be from many causes and the detector 915 may in fact be operative to detect the first prompting signal but for any reason the node device 914 is unable through its failure to issue an effective first responding signal as required by detector 913. For example, there may be a problem with its transceiver 939.

After a predetermined period of time (sufficient to enable a first prompting signal to propagate around the network 900 in the absence of a failure), switch 904A in the control device 902 is temporarily closed, temporarily opening switch 904B, to enable a second prompting signal to be transmitted (by transceiver 931) onto CAN bus line 926 F towards device 922. Detector 925 of device 922 may detect the second prompting signal arriving on CAN bus line 926 F and may close switch 924C in the switching cell 924 of device 922. Transceiver 941 of node device 922 is thus prompted to issue a responding second responding signal, but only after switch 904A has opened after its temporary closure for transmission of the second prompting signal. Detector 903 of the control device 902 detects the second responding signal and thus closes switch 904A definitively and the configuration of the network between devices 902 and 922 is complete.

Switch 924A may then be temporarily closed, temporarily opening switch 924B, to enable the second prompting signal to be transmitted onto CAN bus line 926E (as transmitted by transceivers 941 and 931, and also 933 and 935). Detector 921 of device 918 may detect the second prompting signal arriving on CAN bus line 926E and switch 920C may be closed in the switching cell 920 of device 918. Now that device 918 is connected to CAN bus line 926E via closed switch 920A a second responding signal can be transmitted back along CAN bus line 926E towards device 922. Detector 923 of device 922 may detect the second responding signal arriving on CAN bus line 926E and may close switch 924A definitively. Device 922 is thus reconfigured and has been reconfigured with respect to device 918 to transfer signals between them. In the configuration of device 922, device 922 acts as the prompting node device and device 918 acts as the responding node device.

To continue configuration of the network 900, switch 920A may be temporarily closed (again after a short delay to allow the preceding configuration between devices 922 and 918), temporarily opening switch 920B, to enable the second prompting signal to be transmitted onto CAN bus line 926D. In this example, there is a failure in node device 914, thus the second prompting signal cannot reach device 914 and detector 917 of device 914 cannot detect the second prompting signal (or the device 914 does not effectively act on its detection). As a result, switch 916C in the switching cell 916 of device 914 does not close. Thus, device 914 is not connected to CAN bus line 926D or device 918. Thus, device 914 cannot act as the responding node to prompting node device 918 and the second responding signal cannot be transmitted back along CAN bus line 926D towards device 918. Detector 919 of device 918, therefore, does not detect the second responding signal and thus, switch 920A remains open and switch 920B remains closed. Device 920 is thus reconfigured and has been reconfigured to route signals arriving from CAN bus line 926E to terminator 918T.

In this example reconfigured network, node device 914 containing the failure is isolated from the rest of the network.

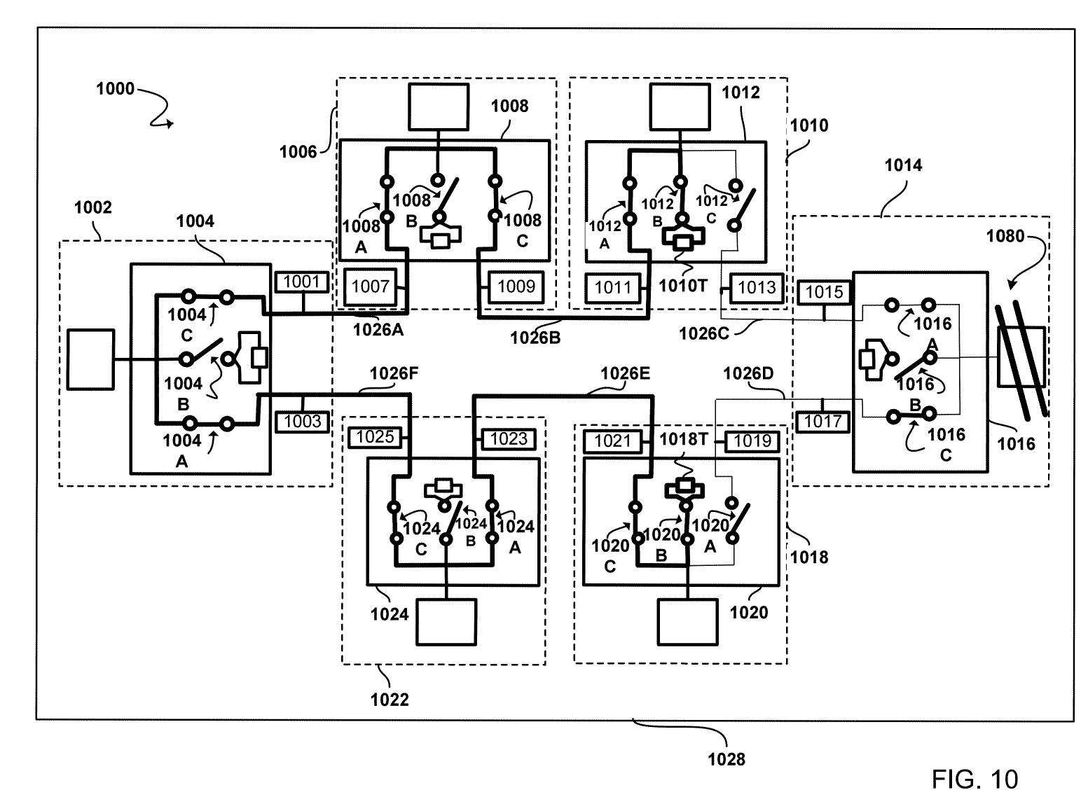

FIG. 10 shows the example network of FIG. 9 in a final reconfigured state.

The bold line indicates the connected CAN bus line capable of transmitting communications between the network devices and the thin line indicates unconnected sections of CAN bus line that are not capable of transmitting communications. The node device containing the failure is isolated from the network by the unconnected sections of CAN bus line. In this figure, signals are terminated at terminator 1010T of device 1010 and terminator 1018T of node device 1018.

The switching cell 100,200 of FIGS. 1 and 2 may be implemented in a number of ways, for example, as discrete switches, as a standard integrated circuit (IC), or an application specific integrated circuit (ASIC), as a field-programmable gate array (FPGA) or by any other means to achieve the result as herein described. In the case that the switching cell is implemented on a FPGA, the switching cell may be configured by a user during setup.

In some examples, the switching cell may be implemented within the transceiver.

In some examples, the CAN bus network may be reconfigured periodically, for example as part of a power-on self-test. However, it is feasible to provide an error detection mechanism within a network, for example in printers comprising a network as described above, by implementing a protocol in which the control device transmits to each device in the bus (for example every 100 ms) a “presence” request message which each device is configured to answer. If a device does not respond to the control device, either because there is a break in the CAN bus line or because there is a fault in a device, the control device can stop all “presence” message transmissions and enter a reconfiguration mode. If a device does not receive a “presence” message within a timeout window it will itself reset, entering into a configuration mode.

Approximately 70% of failures affecting communication on a CAN bus network are generally the result of cabling and connector issues (represented by the failure 620, for example, in FIG. 6). All the devices that implement a CAN network may have a local microcontroller. Generally, if a microcontroller functions correctly in a device, but a hardware problem causes a lack of CAN communications, the microcontroller can diagnose the problem and enter the device in question into a re-configuration mode. Similarly, if the microcontroller functions but a firmware problem causes an issue, the control device can detect the issue and reset the switches. Other failures are commonly related to transceivers and if a problem does relate to a transceiver malfunction, usually the signal levels are affected so the detector of an adjacent device will not detect a good signal and initiate reconfiguration.

If a device has a problem, its microcontroller can generally control the switches. Indeed, the switches (not connected to the terminator in each device) can be arranged when they fail to be open, whereupon, if the problem in the device prevents either switch to close when it should, the device will be isolated through failure to provide a signal as described above.

Since monitoring of the detectors may be performed by the microcontroller of each device in the reconfiguring mode, such detection of signals can be done in a microsecond time domain. So a few milliseconds can be an acceptable time frame for temporary closing of first and third switches A and C. The control device time frame (before it commences to open its third switch A) can be adapted in dependence upon the number of devices, but it can be in the hundreds of milliseconds domain. Should detectors detect good levels in all the CAN buses, the reconfiguration can be done in a very short time.

In some examples, the CAN devices in the CAN bus network as described may be several computers and at least one two-dimensional printing device. In another example, the CAN devices in the CAN bus network may be several computers and at least one three-dimensional printer. The application of the system and methods described are particularly useful when implemented within a three-dimensional printer. In three-dimensional printing a printing job may take several hours. If, during this time, there is a failure in a location of the CAN bus line, all or some of the sub-devices in the printer may lose communication with each other. This loss of communication between the devices may result in a loss of all the printed work up to the time of the failure. Thus, it is especially desirable in the case of a CAN bus network in a three-dimensional printing network that the CAN bus network can be recovered. Furthermore, the method of the present application allows for quick diagnosing of the location of the failure. Again, this is desirable in the case of a CAN bus network within a three-dimensional printer so that the network can be quickly and efficiently repaired. With further reference to FIG. 9, 928 may be a three-dimensional printer and the example CAN bus network 900 may be implemented inside the three-dimensional printer 928.

While the CAN bus network described above employs a closed loop, this does not preclude branches in the network, although there may be a loss of more than one device in a branch beyond a failure at a branch node or in a branch.

Throughout the description and claims of this specification, the words “comprise” and “contain” and variations of them mean “including but not limited to”, and they are not intended to (and do not) exclude other moieties, additives, components or integers. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect or example of the present disclosure are to be understood to be applicable to any other aspect or example described herein unless incompatible therewith. All of the features disclosed in this specification (including any accompanying claims, abstract and drawings), and/or all of the any method or process so disclosed, may be combined in any combination, except combinations where at least some of such features are mutually exclusive. The present disclosure is not restricted to the details of any foregoing examples. The present disclosure extends to any novel one, or any novel combination, of the features disclosed in this specification (including any accompanying claims, abstract and drawings), or to any novel one, or any novel combination, of aspects of any method or process so disclosed.

The reader's attention is directed to all papers and documents which are filed concurrently with or previous to this specification in connection with this application and which are open to public inspection with this specification, and the contents of all such papers and documents are incorporated herein by reference.

The following table shows the reference numerals employed in FIGS. 1 to 10 for each component to which they relate.

| Component | Reference Numeral(s) employed |
|---|---|
| Switching cell showing high and low | 100 |
| differential lines | |
| First switch in switching cell coupled to | 102a |
| high CAN bus line | |
| First switch in switching cell coupled to low | 102b |
| CAN bus line | |
| Second switch in switching cell coupled to | 104a |
| high CAN bus line | |
| Second switch in switching cell coupled to | 104b |
| low CAN bus line | |
| Third switch in switching cell coupled to | 106a |
| high CAN bus line | |
| Third switch in switching cell coupled to | 106b |
| high CAN bus line | |
| Terminator | 108, 208, 300T, T, 614T, 714T, 710T, |
| | 814T, 810T, 910T, 918T, 1010T, |
| | 1018T |
| High CAN bus line | H |
| Low CAN bus line | L |
| Switching cell showing one line to | 200, 304, 504, 508, 512, 516, 604, |
| indicate both high and low differential | 608, 612, 616, 704, 708, 712, 716, |
| lines | 804, 808, 812, 816, 904, 908, 912, |
| | 916, 920, 924, 1004, 1008, 1012, |
| | 1016, 1020, 1024 |
| CAN bus line on a first side of a device | 210, 310 |
| CAN bus line on a second side of a | 212, 312 |
| device | |
| First switch in switching cell | 200A, 304A, 504A, 508A, 512A, 516A, |
| | 604A, 608A, 612A, 616A, 704A, 708A, |
| | 712A, 716A, 804A, 808A, 812A, 816A, |
| | 904A, 908A, 912A, 916A, 920A, 924A, |
| | 1004A, 1008A, 1012A, 1016A, 1020A, |
| | 1024A |
| Second switch in switching cell | 200B, 304B, 504B, 508B, 512B, 516B, |
| | 604B, 608B, 612B, 616B, 704B, 708B, |
| | 712B, 716B, 804B, 808B, 812B, 816B, |
| | 904B, 908B, 912B, 916B, 920B, 924B, |
| | 1004B, 1008B, 1012B, 1016B, 1020B, |
| | 1024B |
| Third switch in switching cell | 200C, 304C, 504C, 508C, 512C, 516C, |
| | 604C, 608C, 612C, 616C, 704C, 708C, |
| | 712C, 716C, 804C, 808C, 812C, 816C, |
| | 904C, 908C, 912C, 916C, 920C, 924C, |
| | 1004C, 1008C, 1012C, 1016C, 1020C, |
| | 1024C |
| CAN bus network device | 300, D1, D2, A, B, 506, 510, 514, 606, |
| | 610, 614, 706, 710, 714, 806, 810, |
| | 814, 906, 910, 914, 918, 922, 1006, |
| | 1010, 1014, 1018, 1022 |
| Detector on a first side of a device | 306, 507, 511, 515, 607, 611, 615, |
| | 707, 711, 715, 807, 811, 815, 907, |
| | 911, 915, 919, 923, 1007, 1011, 1015, |
| | 1019, 1023 |
| Detector on a second side of a device | 308, 509, 513, 517, 609, 613, 617, |
| | 709, 713, 717, 809, 813, 817, 909, |
| | 913, 917, 921, 925, 1009, 1013, 1017, |
| | 1021, 1025 |
| Transceiver | 302, 705, 721, 723, 931, 933, 935, |
| | 937, 941 |
| Failure | F, 620, 720, 820, 980, 1080 |
| First side of a device | S1 |
| Second side of a device | S2 |
| Network of CAN bus network devices | 500, 600, 700, 800, 900, 1000 |
| Control device | 502, 602, 702, 802, 902, 1002 |
| Detector on second side of control | 501, 601, 701, 801, 901, 1001 |
| device | |
| Detector on first side of control device | 503, 603, 703, 803, 903, 1003 |
| Control device terminator | 502T, 602T, 702T |
| CAN bus line coupling the control | 618A, 718A, 818A, 926A, 1026A |
| device and the first node device | |
| CAN bus line coupling the first and | 618B, 718B, 818B, 926B, 1026B |
| second node devices | |
| CAN bus line coupling the second and | 618C, 718C, 818C, 926C, 1026C |
| third node devices | |
| CAN bus line coupling the control | 618D, 718D, 818D, |
| device and the third node device | |
| CAN bus line coupling the third and | 926D, 1026D |
| fourth node devices | |
| CAN bus line coupling the fourth and | 926E, 1026E |
| fifth node devices | |
| CAN bus line coupling the control | 926F, 1026F |
| device and the fifth node device | |

1. A switching cell comprising:
a first switch to couple to a CAN bus line on a first side of the switching cell;
a second switch to couple to a terminator;
a third switch to couple to the CAN bus line on a second side of the switching cell;
wherein the first switch, the second switch and the third switch are to be interconnected; and
wherein the switching cell is configured to transfer signals through the switching cell when the first switch and the third switch are in a closed position and the second switch is in an open position; and
wherein the switching cell is configured to terminate signals when the first switch and the second switch are in the closed position and the third switch is in the open position or the second switch and the third switch are in the closed position and the first switch is in the open position.

2. A CAN bus network device comprising:
a CAN transceiver;
a first detector to detect signals from a CAN bus line on a first side of the device;
a second detector to detect signals from the CAN bus line on a second side of the device; and
the switching cell of claim 1.

3. A network of CAN bus network devices comprising:
a control device comprising the switching cell of claim 1;
a plurality of node devices comprising the switching cell of claim 1;
wherein the control device and each of the plurality of node devices are coupled to two other devices in the network in a closed loop configuration by CAN bus lines.

4. The network of claim 3, wherein at least one of the CAN bus network devices is a three dimensional printer or the CAN bus network is in a three dimensional printer.

5. A method to reconfigure a CAN bus network after a failure comprising:
providing the network with a control device and one or more node devices in a closed loop of CAN bus lines;
detecting if there is a failure in the network; and
reconfiguring the network if a failure is detected, wherein reconfiguring the network when a failure has been detected comprises:
configuring the network to terminate signals on a second side of a first device closest to the failure on one side of the failure;
configuring the network to terminate signals on a first side of a second device closest to the failure on the other side of the failure; and
coupling a first side of each device with a second side of an adjacent device, other than the first side of the second device and the second side of the first device.

6. The method of claim 5, further comprising decoupling each of the plurality of devices in the network from the CAN bus line when a failure is detected.

7. The method of claim 5, wherein detecting a failure in the network further comprises:
transmitting a first prompting signal from the control device onto the CAN bus line on a second side of the control device;
monitoring the CAN bus line on a first side of the control device for the first prompting signal;
wherein there is not a failure in the network if the first prompting signal is detected by a first detector of the control device; and
wherein there is a failure in the network if the first prompting signal is not detected by the first detector of the control device.

8. The method of claim 7, further comprising:
providing each device with a switching cell having a first switch, a second switch and a third switch, wherein transmitting a first prompting signal from the control device comprises:
closing the third switch in the switching cell in the control device.

9. The method of claim 8, further comprising:
providing each switching cell with a terminator coupled to the second switch, and
decoupling each of the plurality of devices in the network from the CAN bus line, wherein the decoupling comprises:
opening the first switch in each of the plurality of devices to disconnect each of the plurality of devices from the CAN bus line on the first side of each of the plurality of devices;
opening the third switch in each of the plurality of devices to disconnect each of the plurality of devices from the CAN bus line on the second side of each of the plurality of devices; and
closing a second switch in the switching cell in each of the plurality of devices to connect each device to the terminator.

10. The method of claim 9, wherein, when there is a failure in the network, the configuring of the network to terminate signals in the devices closest to the failure in the network comprises;
configuring each pair of adjacent devices in turn, wherein one of each pair serves as a prompting device and the other as a responding device;
providing each of the devices with a first detector on the first side of each device and a second detector on the second side of each device;
temporarily closing the third switch in the switching cell in the prompting device to transmit a prompting signal to the responding device;
closing the first switch in the switching cell in the responding device when the prompting signal is detected by the second detector of the responding device; and
opening the third switch in the switching cell in the prompting device; whereupon either:
the third switch is definitively closed in the switching cell in the prompting device when a responding signal is detected by the first detector of the prompting device, and the second switch opens to isolate the terminator; or
the third switch remains open when the first detector of the prompting device does not detect a responding signal, and the second switch is closed so that the prompting device routes signals to the terminator.

11. The method of claim 10, wherein configuring each pair of adjacent devices in turn:
commences between the control device and a first node device on the second side of the control device,
proceeds between succeeding pairs of adjacent devices until the failure is reached and the third switch of the node device closest to the failure remains open when the first detector of that device does not detect a responding signal; and
continues in a reverse direction between the control device and a second node device on the first side of the control device, and
proceeds in reverse between succeeding pairs of adjacent devices until the failure is reached and the first switch of the node device closest to the failure remains open when the second detector of that device does not detect a responding signal.

12. The method of claim 9, wherein, when there is not a failure in the network,
terminating the CAN bus line on the first side of the control device and on the second side of the node device connected to the control device.

13. A computer readable medium comprising instructions that, when executed on a processor, perform the actions of:
detecting if there is a failure in the network; and
reconfiguring the network if a failure is detected, wherein reconfiguring the network when a failure has been detected comprises:
configuring the network to terminate signals on a second side of a first device closest to the failure on one side of the failure;
configuring the network to terminate signals on a first side of a second device closest to the failure on the other side of the failure; and
coupling a first side of each device with a second side of an adjacent device, other than the first side of the second device and the second side of the first device.

14. The computer readable medium of claim 13, further comprising instructions that, when executed on a processor, perform the method of any one of claims 5 to 12.
